(19) United States
(12) Patent Application Publication
(10) Pub. No.: US 2023/0024728 A1
(43) Pub. Date: Jan. 26, 2023

(54) FUNDING A GAMING ESTABLISHMENT ACCOUNT AS PART OF A FINANCIAL ACCOUNT REWARDS PROGRAM

(71) Applicant: IGT, Las Vegas, NV (US)

(72) Inventors: Kevin Higgins, Reno, NV (US); Jeffery Shepherd, Reno, NV (US)

(21) Appl. No.: 17/382,026

(22) Filed: Jul. 21, 2021

(51) Int. Cl. G07F 17/32

(52) U.S. Cl. CPC G07F 17/3244

(57) ABSTRACT

Systems and methods that utilize funds associated with a financial account rewards program to modify an amount maintained in association with a gaming establishment account.

### BACKGROUND

In various embodiments, the systems and methods of the present disclosure utilize funds associated with a financial account rewards program to modify an amount maintained in association with a gaming establishment account.

Certain credit card rewards programs enable members to earn rewards of some form that accumulate at a percentage of the amount spent using their credit cards. For example, a consumer may earn 1% cashback on all retail purchases made using a credit card affiliated with that credit card rewards program. In another example, a consumer may earn points on retail purchases made using a credit card affiliated with that credit card rewards program. In this example, once a certain threshold of points is reached, the points can be redeemed for a free plane ticket or other goods.

### BRIEF SUMMARY

In certain embodiments, the present disclosure relates to a system including a processor, and a memory device that stores a plurality of instructions. When executed by the processor following an approved purchase made in association with a financial account maintained for a user by a financial institution and responsive to a gaming establishment account contribution event, the instructions cause the processor to cause an amount to be contributed to a gaming establishment account associated with the user, wherein the amount contributed to the gaming establishment account is based on a purchase contribution rate and an amount of the approved purchase. When executed by the processor responsive to the amount contributed to the gaming establishment account associated with the user, the instructions cause the processor to communicate data that results in a display, by a display device, of the amount contributed to the gaming establishment account, and automatically initiate an activity associated with a gaming establishment, wherein the activity is at least partially funded by at least part of the amount contributed to the gaming establishment account.

In certain embodiments, the present disclosure relates to a system including a processor, and a memory device that stores a plurality of instructions. When executed by the processor responsive to an approved purchase made in association with a financial account maintained for a user by a financial institution and responsive to a gaming establishment account contribution event, the instructions cause the processor to determine a benefit, wherein the benefit is determined independent of any wagering activity occurring in association with any gaming establishment and an amount of the benefit is based on a purchase contribution rate and an amount of the approved purchase. When executed by the processor, the instructions cause the processor to cause the determined benefit to be contributed to a gaming establishment account associated with the user, and cause the determined benefit to be automatically applied toward a wagering activity occurring in association with a gaming establishment.

In certain embodiments, the present disclosure relates to a method of operating a system. Following an approved purchase made in association with a financial account maintained for a user by a financial institution and responsive to a gaming establishment account contribution event, the method includes causing, by a processor, an amount to be contributed to a gaming establishment account associated with the user, wherein the amount contributed to the gaming establishment account is based on a purchase contribution rate and an amount of the approved purchase. Responsive to the amount contributed to the gaming establishment account associated with the user, the method includes displaying, by a display device, the amount contributed to the gaming establishment account, and automatically initiating, by the processor, an activity associated with a gaming establishment, wherein the activity is at least partially funded by at least part of the amount contributed to the gaming establishment account.

Additional features are described herein, and will be apparent from the following Detailed Description and the figures.

### BRIEF DESCRIPTION OF THE FIGURES

FIG. 1 is an example configuration of the architecture of a plurality of different components of the system of the present disclosure.

FIG. 2A is a flow chart example process for operating a system of the present disclosure which provides a benefit in association with a financial account rewards program.

FIGS. 2B, 2C and 2D are flow chart example processes for operating a system of the present disclosure which provides a benefit in association with a financial account rewards program, wherein the provided benefit is automatically exchanged for an opportunity to win another benefit.

FIG. 3 is an example chart illustrating the different benefits available in accordance with the system of the present disclosure for different purchases made in association with the financial account rewards program.

### DETAILED DESCRIPTION

In various embodiments, the system of the present disclosure allocates zero, one or more benefits to one or more gaming establishment accounts associated with a user responsive to the user utilizing an instrument associated with a qualifying financial account to purchase goods and/or services.

In certain embodiments, upon a gaming establishment account contribution event, the system contributes part or all of a benefit determined in association with a financial account rewards program to a gaming establishment account associated with the user. In these embodiments, a user utilizes a qualifying financial instrument, such as a credit card or debit card, associated with a financial account to purchase goods and/or services over a period of time (i.e., a qualifying retail spend). Upon a qualifying retail spend reporting event, the system operates with one or more components of a financial institution which maintains the financial account to determine a benefit based on an amount of the qualifying retail spend and to contribute the determined benefit to a gaming establishment account associated with the user, such as a cashless wagering account associated with the user. Following the contribution of the determined benefit to the gaming establishment account associated with the user, the system enables the user to redeem the benefit (or the system automatically redeems the benefit) in association with one or more activities occurring at or otherwise associated with the gaming establishment. Such a configuration enables a user to leverage economic activity occurring independent of any gaming establishment to obtain a benefit redeemable in association with the gaming establishment.

In certain embodiments, different goods and/or services purchased using the qualifying instrument associated with the financial account are associated with different contributions to the gaming establishment account associated with the user. For example, if a consumer purchases $1000 worth of goods in a first class of goods over a monthly billing cycle using a credit card associated with a 2% rewards program for that first class of goods and the consumer also purchases $1000 worth of goods in a second class of goods over the monthly billing cycle using the same credit card associated with a 1% rewards program for that second class of goods, upon the conclusion of the monthly billing cycle (i.e., the qualifying retail spend reporting event), the system operates with a server of the financial institution that issued the credit card to contribute $30 ($1000×0.02 for the qualifying retail spend on the first class of goods+$1000×0.01 for the qualifying retail spend on the second class of goods) to a gaming establishment account associated with the user. In certain other embodiments, different goods and/or services purchased using the qualifying instrument associated with the financial account are additionally or alternatively associated with different types of contributions to different gaming establishment accounts associated with the user. For example, if a consumer purchases $1000 worth of goods in a first class of goods over a monthly billing cycle using a credit card associated with a 1% cashable credit rewards program for that first class of goods and the consumer also purchases $1000 worth of goods in a second class of goods over the monthly billing cycle using the same credit card associated with a 10% player tracking point rewards program for that second class of goods, upon a determination of a rewards program annual bonus (i.e., the qualifying retail spend reporting event), the system operates with a server of the financial institution that issued the credit card to contribute $10 to a cashless wagering account associated with the user and to also contribute 100 player tracking points to a player tracking account associated with the user.

In certain embodiments, following one or more benefits deposited into one or more gaming establishment accounts associated with the user, the system automatically utilizes part or all of the benefit in association with one or more forms of wagering activities associated with a gaming establishment. In certain such embodiments, the system automatically contributes part or all of the benefit determined in association with the financial account rewards program to a progressive award pool. In these embodiments, if the contribution to the progressive award pool causes a progressive award triggering event to occur, such as upon the contribution causing the progressive award pool to reach a randomly determined amount or if the contribution is the first contribution after a randomly determined point in time, the system causes part or all of the progressive award pool to be contributed to the gaming establishment account associated with the user. In certain other embodiments, the system automatically utilizes part or all of the deposited benefit to purchase one or more entries into a drawing for an award. In these embodiments, if the system determines that a purchased entry is a winning entry, the system causes part or all of the award for winning the drawing to be contributed to the gaming establishment account associated with the user. It should be appreciated that in these embodiments, the potential award for winning the progressive award pool and/or the award for winning the entered drawing is disproportionally larger than the benefit determined for the qualifying purchases made in association with the financial account rewards program. Such a configuration introduces an element of risk to a financial account rewards program by enabling consumers to potentially obtain life changing awards otherwise not available from existing financial account rewards programs. Such a configuration further provides that while the funds deposited into a gaming establishment account associated with the user occur independent from any gaming establishment activity and thus are based on economic activity that is decoupled from any wagering activity at any gaming establishment, such funds may still be subsequently used, independent of any user intervention, to participate in wagering activity associated with a gaming establishment.

In certain embodiments, following the gaming establishment account contribution event and one or more benefits deposited into one or more gaming establishment accounts associated with the user, the system automatically utilizes part or all of the benefit in association with one or more forms of non-wagering activities associated with a gaming establishment. In one such embodiment, the system automatically utilizes part or all of the benefit obtained in association with the use of the qualifying instrument associated with the financial account to purchase goods and/or services to settle part or all of an outstanding line of credit or marker associated with the user. Such a configuration offers an automatic way for a user to pay off outstanding debts associated with a gaming establishment independent of any activity associated with the gaming establishment.

In various embodiments, as part of allocating zero, one or more benefits to one or more gaming establishment accounts associated with a user responsive to the user utilizing an instrument associated with a qualifying financial account to purchase goods and/or services, the system of the present disclosure operates with (or otherwise comprises) a gaming establishment fund management system including various components or sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a player and/or retail patron, collectively form a resort or enterprise account (i.e., an integrated resort or gaming establishment fund management wallet) that the user may access to transfer funds and/or view balance information amongst the various accounts associated with or otherwise maintained for the user.

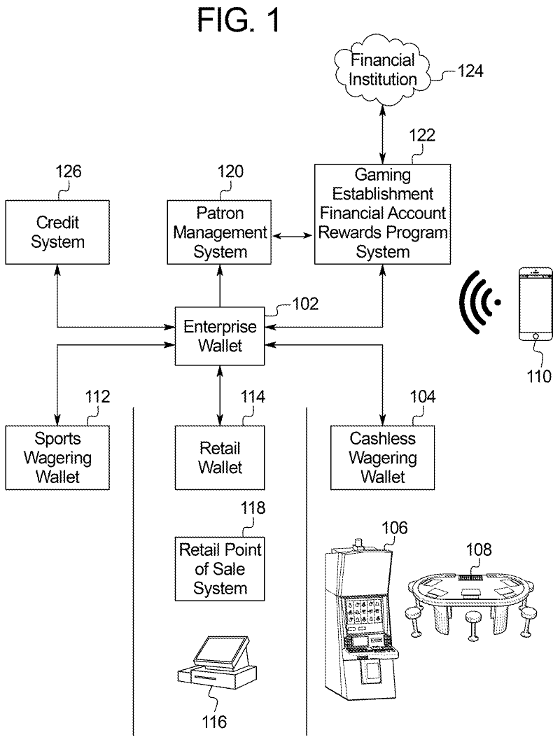

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a player tracking unit associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo machine located on a casino floor and/or a sports betting terminal (that offers wagering games and sports betting opportunities)). For example, as seen in FIG. 1, the gaming establishment fund management system includes a first cashless wagering system (not shown) that maintains a Cashless Wagering Wallet 104 (e.g., a first cashless wagering account) which is in communication with an enterprise wallet 102. In this example, to facilitate the transfer of funds from this cashless wagering account to a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 102. In this example, to facilitate the transfer of funds from this cashless wagering account to a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 102. In this example, to facilitate the transfer of funds from this gaming establishment retail account to an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer, and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

It should be appreciated that in various embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In certain embodiments (not shown), the gaming establishment fund management system is in communication with one or more external funding sources which maintain one or more external accounts for the user. For example, the gaming establishment fund management system that maintains the enterprise wallet is in communication with a network of one or more banks or other financial institutions which operate to electronically transfer funds from the user's accounts maintained at such banks or financial institutions to one or more of the accounts maintained by the gaming establishment fund management system. In certain embodiments, such external accounts include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any component or sub-system of the present disclosure can be in communication with one or more external funding sources. In different embodiments, the system utilizes a mobile device running a mobile device application, a kiosk, an EGM, a remote host controlled service window displayed by an EGM, a component of a gaming establishment patron management system, such as a player tracking unit, and/or a gaming establishment interface to facilitate the transfer of funds from a third-party account.

In certain embodiments, the gaming establishment fund management system is in communication with one or more gaming establishment patron management systems. For example, as seen in FIG. 1, the gaming establishment fund management system (i.e., enterprise wallet 102) is in communication with one or more gaming establishment patron management systems (i.e., the patron management system 120) that assists in the creation of one or more accounts as well as provide rewards, such as redeemable player tracking points, in association with the financial account rewards program (and monitor activities at various points of contact associated with a gaming establishment and provides rewards, such as redeemable player tracking points, in association with such activities). It should be appreciated that any component or sub-system of the present disclosure can be in communication with one or more gaming establishment patron management systems.

In certain embodiments, to provide one or more benefits in association with a financial account rewards program, the gaming establishment fund management system is in communication with one or more components that process financial account rewards program activities communicated from one or more financial institutions that offer financial accounts associated with such programs. For example, as seen in FIG. 1 and described in more detail below, the gaming establishment fund management system includes or is otherwise in communication with a gaming establishment financial account rewards program system 122 which is in communication with the enterprise wallet 102 (to communicate data regarding cash/credits earned from the financial account rewards program), the patron management system 120 (to communicate data regarding player tracking points earned from the financial account rewards program) and one or more components of a financial institution 124 (to receive data regarding qualifying retail spending associated with a financial instrument associated with a financial account maintained by the financial institution). It should be appreciated that while illustrated as the gaming establishment fund management system being in communication with one or more gaming establishment financial account rewards program systems, in different embodiments, any component or sub-system of the present disclosure can be in communication with one or more gaming establishment financial account rewards program systems. It should be further appreciated that the financial institutions that offer financial accounts associated with financial account rewards programs may be the same financial institution or a different financial institution from the financial institution that operate to electronically transfer funds from the user's accounts maintained at such financial institutions to one or more of the accounts maintained by the gaming establishment fund management system.

In certain embodiments (not shown), the gaming establishment fund management system is in communication with one or more financial account rewards program bonusing systems, such as a progressive award server and/or a drawing manager, which operate to offer one or more opportunities for a user to wager part or all of any contributions to a gaming establishment account made in association with the financial account rewards program. In these embodiments, the financial account reward program bonusing system receives, from the gaming establishment financial account rewards program system, data regarding certain benefits earned from the financial account reward program which is to be risked to potentially win one or more awards. In certain such embodiments, one or more components of the system inform the user that a portion of any benefits earned from the financial account reward program are risked to potentially win in a potentially more lucrative award, such as a mystery progressive award. In certain other embodiments, no components of the system inform the user that a portion of any benefits earned from the financial account reward program are risked to potentially win in a potentially more lucrative award and the contribution amount is deducted as part of the rewards percentages offered to users (e.g., a cashback percentage of purchases made associated with a cashback rewards program is reduced 0.5% to pay for any contribution to a mystery progressive award, but users may not be aware of that reduction and only are informed about the final cashback percentage). In these different embodiments, upon the financial account reward program bonusing system determining that a user is entitled to an award in association with the risked benefit, the financial account reward program bonusing system communicates, to the enterprise wallet, data associated with such an award to modify the balance of one or more gaming establishment accounts associated with the user.

In certain embodiments, the gaming establishment fund management system is in communication with one or more credit systems which each issue the user one or more lines of credit or markers. For example, as seen in FIG. 1, the gaming establishment fund management system that maintains the enterprise wallet 102 is in communication with a gaming establishment credit system (i.e., the credit system 126) to facilitate the establishment of an amount of funds in the gaming establishment fund management account via one or more lines of credits. In this example, to facilitate a transfer of funds from the line of credit issued by the credit system to a cashless wagering account (and then to a credit balance of an EGM 106 and/or a credit balance of a gaming table component (not shown) associated with a gaming table 108), the system utilizes a mobile device 110 running a mobile device application that interfaces with one or more components of the credit system to enable a user, such as a player of the EGM or a player at the gaming table, access to the issued line of credit. It should be appreciated that while illustrated as the gaming establishment fund management system being in communication with one or more credit systems, in different embodiments, any component or sub-system of the present disclosure can be in communication with one or more credit systems.

In certain embodiments (not shown), the gaming establishment fund management system is also in communication with one or more credit reporting/credit risk systems which monitor and report on various accounts associated with the user. For example, the gaming establishment fund management system that maintains the enterprise wallet is in communication with one or more credit reporting and risk systems. These credit reporting and risk systems monitor and report on a credit rating and status of one or more accounts maintained for the user at various funding sources, such as various financial institutions. It should be appreciated that while illustrated as the gaming establishment fund management system being in communication with one or more credit reporting networks and one or more credit reporting/credit risk systems, in different embodiments, any component or sub-system of the present disclosure can be in communication with one or more credit reporting/credit risk systems.

In certain embodiments, the system utilizes one mobile device application to interact with the different components of the gaming establishment fund management system to access funds maintained in the different gaming establishment accounts associated with the user. For example, utilizing the same mobile application, a mobile device interacts with both the first cashless wagering system of the gaming establishment fund management system and the credit system in communication with the gaming establishment fund management system. In certain embodiments, the system utilizes multiple mobile device applications to interact with the different components of the gaming establishment fund management system to access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to access funds associated with different gaming establishment accounts, the system utilizes a kiosk, an EGM, a remote host controlled service window displayed by an EGM, a display device/input device associated with a seat-level gaming table component, a display device/input device associated with a table-level gaming table component, a display device/input device associated with a mobile gaming table component, a component of a gaming establishment patron management system, such as a player tracking unit, and/or a gaming establishment interface, such as a casino desk, to access the funds associated with such gaming establishment accounts. It should be further appreciated that while illustrated in FIG. 1 as using a mobile device running a mobile device application to access funds associated with different gaming establishment accounts (e.g., a cashless wagering account and a gaming establishment retail account), a physical instrument, such as a smart card or a user issued magnetic striped card may additionally or alternatively be utilized to enable a user access to such gaming establishment accounts.

In various embodiments, prior to earning any benefits independent of any activity occurring at a gaming establishment and which may redeemed in association with a gaming establishment, the system enables a user to sign up for a financial account associated with a financial account rewards program. In certain embodiments, as part of the signing up process, the system requires the user to either associate the financial account associated with the financial account rewards program with the user's gaming establishment fund management account, such as the enterprise account, or establish a gaming establishment account that is then associated with the financial account associated with the financial account rewards program.

In certain embodiments, to set up a gaming establishment fund management account, certain current jurisdictional regulations require that a patron must provide various identifying information, such as a name and a social security number. In certain embodiments wherein the user currently has a gaming establishment patron management system account, such as a player tracking account, but not a gaming establishment fund management account, to set up a gaming establishment fund management account, in addition to potentially utilizing certain identifying information previously obtained in association with the gaming establishment patron management system account, the system requires the user to provide certain additional identifying information. This additional identifying information is required to set up the gaming establishment fund management account but not necessarily required to set up the gaming establishment patron management system account. In these embodiments, following the user associating a financial account associated with the financial account rewards program with an existing gaming establishment fund management account or providing certain additional identifying information required to set up the gaming establishment fund management account which the system then associates with the financial account associated with the financial account rewards program, the system enables the user to earn benefits in association with certain purchases made using a financial instrument associated with the financial account.

In certain embodiments, in addition to associating the gaming establishment fund management account with the financial account associated with the financial account rewards program, the system determines whether or not any benefits earned in association with certain purchases made using a financial instrument associated with the financial account are redeemable by the user. In these embodiments, the system determines whether any jurisdictional regulations are in place that require that prior to using funds in a gaming establishment fund management account to place any wagers, gaming establishment personnel must verify that the user is in fact the person pictured in a government issued identification, such as a driver's license or passport, that the user presents to the gaming establishment personnel. If such jurisdictional regulations are not in place, the system enables any benefits earned in association with the financial account rewards program to be immediately redeemed by the user. On the other hand, if such jurisdictional regulations are in place, the system designates the gaming establishment fund management account as operable to earn benefits in association with the financial account rewards program, but not operable to redeem benefits earned in association with the financial account rewards program (until such time that the user complies with the jurisdictional regulations). Such a configuration provides that rather than requiring the user to first show up in person at a gaming establishment before enabling the user to earn benefits from the financial account rewards program associated with the gaming establishment, the system enables benefits to be earned, but not redeemed until the user has verified their identity. That is, since it would be inconvenient to force a user to show up in person at a casino before they can leverage their casino-branded credit card if that user established a gaming establishment fund management account for the first time and signed up for the casino-branded credit card remotely, the system enables the gaming establishment fund management account to receive deposits, but not withdrawals until the user performs the jurisdictionally required identity validation steps.

In certain embodiments, following the association of the gaming establishment account with the financial account associated with the financial account rewards program, the user may proceed to make purchases against the financial account and earn benefits in association with the financial account rewards program for doing so. In these embodiments, to make a purchase (which may or may not earn a benefit deposited into a gaming establishment account), following a user's attempt to use a qualifying financial instrument, such as a credit card, at a point-of-sale terminal in a retail establishment, the point-of-sale terminal communicates the purchase request to a banking network server, such as a credit card network server. The purchase request includes information associated with the attempted transaction, such as, but not limited to, the time and date of the attempted purchase, the amount of the attempted purchase, merchant identifying information, and financial account identifying information. The banking network server in turn communicates the information associated with the attempted transaction to a server of the financial institution which issued the financial instrument (i.e., an issuer financial institution server), such as the issuer bank server or issuer credit union server. In these embodiments, the issuer financial institution server then proceeds with approving or denying the attempted purchase.

If the issuer financial institution server denies the attempted purchase, such as if the issuer financial institution server detects that the transaction may be fraudulent or if the issuer financial institution server determines that the amount of the attempted purchase exceeds a credit limit associated with the financial account, the issuer financial institution server communicates a denial of the transaction to the point-of-sale terminal through the banking network server. On the other hand, if the issuer financial institution server approves the attempted purchase, the issuer financial institution server communicates an approval of the transaction to the point-of-sale terminal through the banking network server. If the issuer financial institution server approves the attempted purchase, the issuer financial institution server also updates the financial account associated with the approved purchase (i.e., to reflect the purchase) and communicates fund transfer data associated with the amount of the approved purchase to a merchant bank server (i.e., a server of the financial institution associated with the retail establishment) which updates one or more financial accounts associated with the retail establishment to reflect the amount of the approved purchase. In addition to approving or denying the attempted purchase, if the issuer financial institution server approves the attempted purchase, the issuer financial institution server records the approved amount of the purchase (and, in certain embodiments, an applicable purchase contribution rate, the location of the purchase, an applicable merchant category code associated with the purchase) in association with the applicable rewards program.

In addition to the user making zero, one or more purchases against the financial account and potentially earning benefits in association with the financial account rewards program for doing so, the gaming system periodically determines if a gaming establishment account contribution event has occurred. In certain embodiments, a gaming establishment account contribution event occurs when a component of a financial institution, such as the issuer financial institution server, notifies the system of activity associated with the user of the financial account enrolled in the rewards program. For example, if a credit card cashback rewards program issues any benefits at the end of a billing period (e.g., monthly) or a designated period of time (e.g., yearly), then the gaming establishment account contribution event occurs in association with such timeframes.

In certain embodiments, upon an occurrence of a gaming establishment account contribution event, the system undertakes one or more actions to process zero, one or more benefits and deposit such benefits in one or more gaming establishment accounts, wherein the actions undertaken by the system are based on the configuration of the gaming establishment financial account rewards program system and information associated with the user's gaming establishment account.

In certain embodiments, a component of a financial institution, such as a server of an issuer financial institution system, notifies the gaming establishment financial account rewards program system of the amount to be contributed in the user's gaming establishment account associated with the user's financial account. In these embodiments, the issuer financial institution system provides the exact amount of funds to credit to a user's gaming establishment account (based on the amount of approved purchases and an applicable purchase contribution rates for each approved purchase) and the gaming establishment financial account rewards program system processes such contributions to one or more gaming establishment accounts.

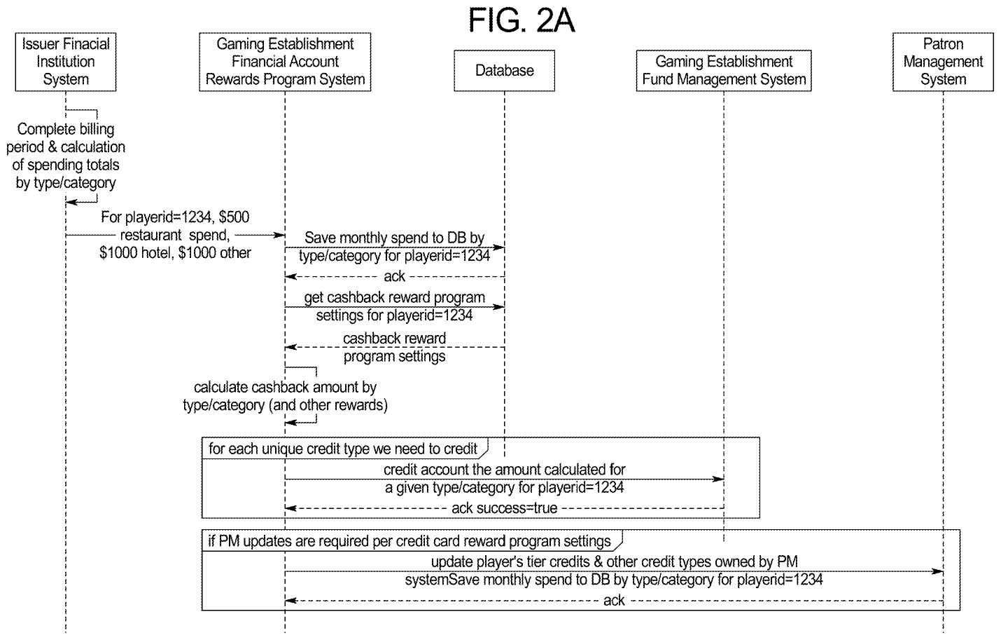

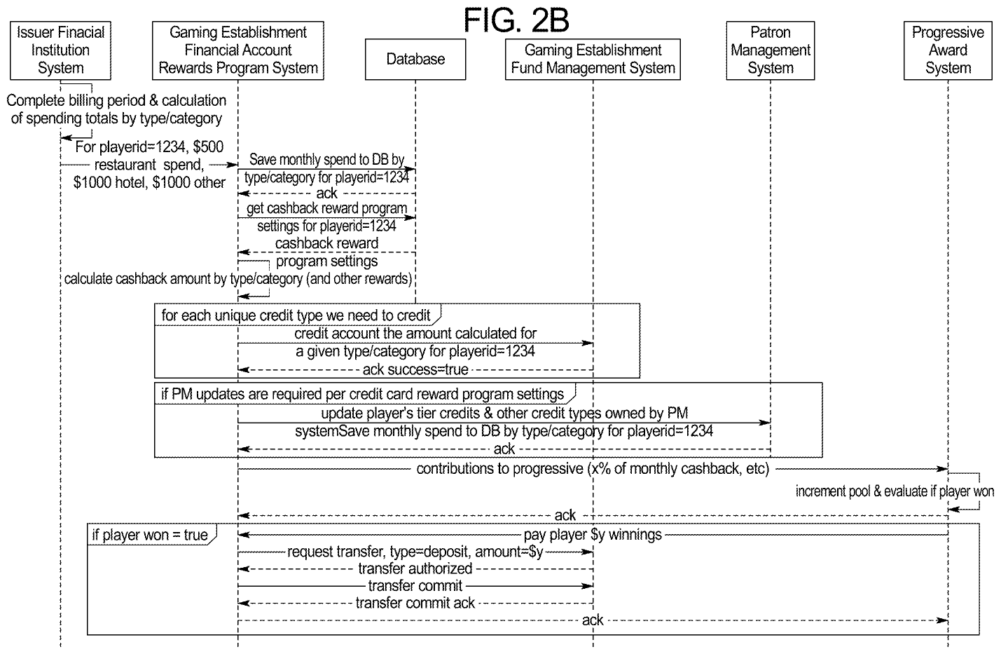

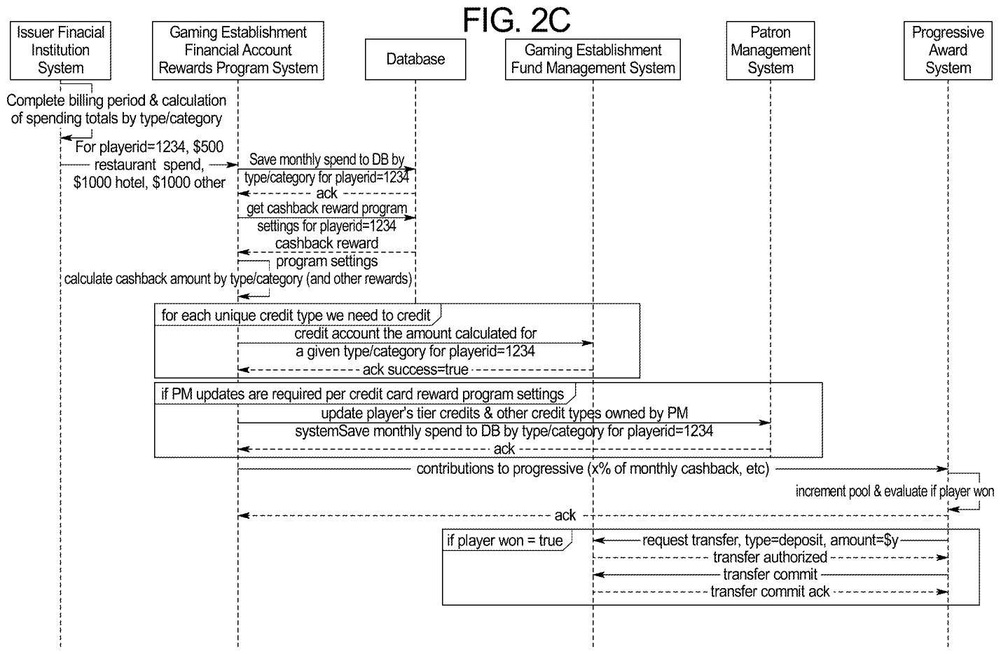

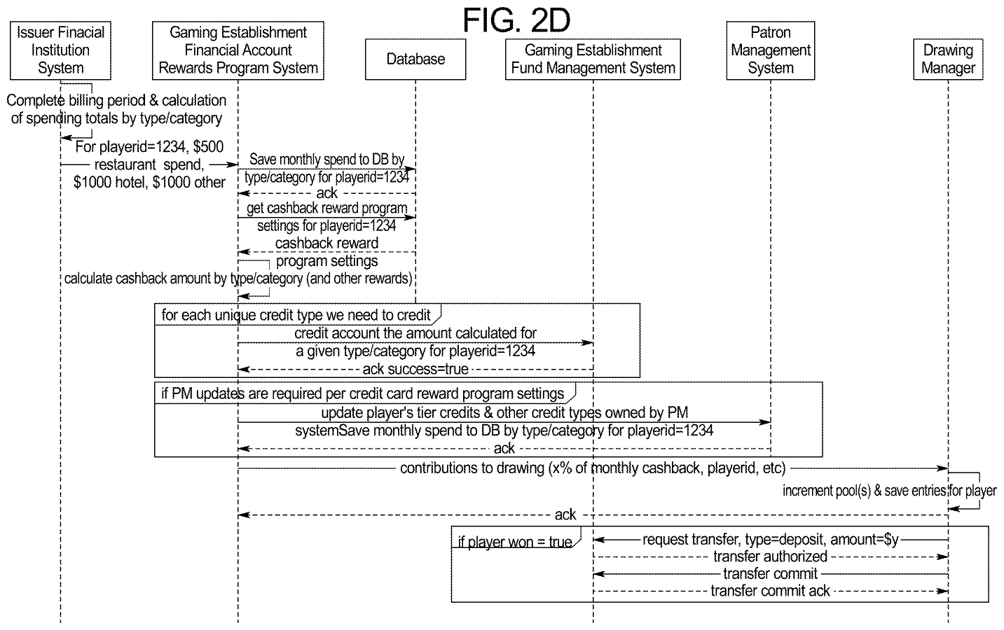

In certain embodiments, a component of a financial institution, such as the server of the issuer financial institution system, notifies the gaming establishment financial account rewards program system of the amount approved for purchases since the last gaming establishment account contribution event. In these embodiments, the gaming establishment financial account rewards program system determines, based on the amount of approved purchases and an applicable purchase contribution rate, the amount to be contributed to the user's gaming establishment account associated with the user's financial account. That is, if an issuer financial institution system does not provide the exact amount of funds to credit to a user's gaming establishment account, then the gaming establishment financial account rewards program system performs one or more calculations of the user's reported approved spend over the applicable billing period to determine a benefit to contribute to one or more gaming establishment accounts. For example, as seen in FIG. 2A, a plurality of components of the system (e.g., a gaming establishment financial account rewards program system, a database which maintain the configuration of the financial account rewards program, and a gaming establishment fund management system) operate with one or more components external from the system (e.g., an issuer financial institution system) such that upon an occurrence of a gaming establishment account contribution event, the issuer financial institution system notifies the gaming establishment financial account rewards program system of various data associated with one or more qualifying purchases to enable the gaming establishment financial account rewards program system to determine a benefit to contribute to one or more gaming establishment accounts.

In certain embodiments, a component of a financial institution, such as the server of the issuer financial institution, notifies the gaming establishment financial account rewards program system of the purchases made since the last gaming establishment account contribution event and the location of such purchases (identified by type of spend). In these embodiments, the gaming establishment financial account rewards program system determines, based on the amount of approved purchases by type of spend and the applicable purchase contribution rate for each type of spend, the amount to be contributed to the user's gaming establishment account associated with the user's financial account. For example, if the financial account rewards program is configured with a varying cashback award, then following the issuer financial institution system communicating to the gaming establishment financial account rewards program system that the user spent $500 at restaurants for the applicable billing period, $500 at hotels for the applicable billing period, and $2000 at other locations for the applicable billing period, the gaming establishment financial account rewards program system applies the appropriate purchase contribution rate for each identified tier and credits one or more gaming establishment accounts associated with the user accordingly.

In certain embodiments, one or more components of the issuer financial institution system (and/or one or more components of the gaming establishment financial account rewards program system) associated with different rewards programs applies the same purchase contribution rate (i.e., the percentage or portion of the amount of the purchase price of a good and/or service which is credited to one or more gaming establishment accounts as a benefit) to each rewards program. In certain embodiments, one or more components of the issuer financial institution system (and/or one or more components of the gaming establishment financial account rewards program system) associated with different rewards programs applies different purchase contribution rates for such different rewards programs. In these embodiments, the different purchase contribution rates represent different reward program benefits associated with a user choosing one financial account over another financial account. For example, a credit card which contributes 2% of the purchase price of a qualifying good and/or service to a gaming establishment account may be deemed by certain users as having a more lucrative rewards program than a credit card which contributes 1% of the purchase price of a qualifying good and/or service to the gaming establishment account.

In certain embodiments, one or more components of the issuer financial institution system (and/or one or more components of the gaming establishment financial account rewards program system) applies the same contribution rate independent of the merchant whom sold the qualifying good and/or service. In another embodiment, one or more components of the issuer financial institution system (and/or one or more components of the gaming establishment financial account rewards program system) applies different contribution rates based on the merchant whom sold the qualifying good and/or service (which is funded by the manufacturer of the purchased good, the provider of the purchased service, the user and/or a third party). For example, qualifying purchases made at a first merchant are associated with a contribution rate of 1% of the purchase price and qualifying purchases made at a second, different merchant are associated with a contribution rate of 2% of the purchase price.

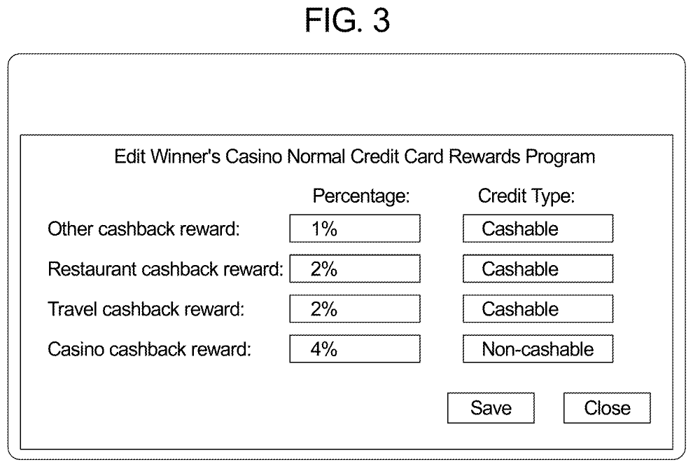

In certain embodiments, one or more components of the issuer financial institution system (and/or one or more components of the gaming establishment financial account rewards program system) applies the same contribution rate independent of the type of qualifying good and/or service. In another embodiment, one or more components of the issuer financial institution system (and/or one or more components of the gaming establishment financial account rewards program system) applies different contribution rates based on the type of qualifying good and/or service (which is funded by the manufacturer of the purchased good, the provider of the purchased service, the user and/or a third party). For example, as seen in FIG. 3, qualifying purchases of a first type of qualifying good and/or service (e.g., qualifying purchases made on travel related services) are associated with a contribution rate of 2% of the purchase price and qualifying purchases of a second, different type of qualifying good and/or service (e.g., qualifying purchases made on casino related services) are associated with a contribution rate of 4% of the purchase price.

In certain embodiments, one or more components of the issuer financial institution system (and/or one or more components of the gaming establishment financial account rewards program system) applies the same contribution rate independent of the value of the qualifying goods and/or services. In another embodiment, a server of the issuer financial institution system (and/or one or more components of the gaming establishment financial account rewards program system) applies different contribution rates based on the value of the qualifying purchased goods and/or services (which are funded by the manufacturer of the purchased good, the provider of the purchased service, the user and/or a third party). For example, qualifying purchases under $999.99 are associated with a contribution rate of 1% of the purchase price and qualifying purchases over $1000.00 are associated with a contribution rate of 2% of the purchase price.

In certain embodiments, one or more components of the issuer financial institution system (and/or one or more components of the gaming establishment financial account rewards program system) determines the same type of benefit independent of the merchant whom sold the qualifying good and/or service. In another embodiment, one or more components of the issuer financial institution system (and/or one or more components of the gaming establishment financial account rewards program system) determines different types of benefits based on the merchant whom sold the qualifying good and/or service. For example, qualifying purchases made at a first merchant are associated with a first benefit in the form of cashable credits deposited into a gaming establishment account and qualifying purchases made at a second, different merchant are associated with a second benefit in the form of non-cashable credits deposited into a gaming establishment account.

In certain embodiments, one or more components of the issuer financial institution system (and/or one or more components of the gaming establishment financial account rewards program system) determines the same type of benefit independent of the type of qualifying good and/or service. In another embodiment, one or more components of the issuer financial institution system (and/or one or more components of the gaming establishment financial account rewards program system) determines different types of benefits based on the type of qualifying good and/or service. For example, as seen in FIG. 3, qualifying purchases of a first type of qualifying good and/or service (e.g., qualifying purchases made on travel related services) are associated with a first benefit in the form of cashable credits deposited into a gaming establishment account and qualifying purchases of a second, different type of qualifying good and/or service (e.g., qualifying purchase made on casino related services) are associated with a second benefit in the form of non-cashable credits deposited into a gaming establishment account.

In certain embodiments, one or more components of the issuer financial institution system (and/or one or more components of the gaming establishment financial account rewards program system) determines the same type of benefit independent of the value of the qualifying good and/or service. In another embodiment, one or more components of the issuer financial institution system (and/or one or more components of the gaming establishment financial account rewards program system) determines different types of benefits based on the value of qualifying purchased good and/or service. For example, qualifying purchases under $999.99 are associated with a first benefit in the form of cashable credits deposited into a gaming establishment account and qualifying purchases over $1000.00 are associated with a second benefit in the form of non-cashable credits deposited into a gaming establishment account.

In certain embodiments wherein the gaming establishment account that receives the benefit in association with the financial account rewards program is a gaming establishment fund management account (e.g., a cashless wagering account and/or a gaming establishment retail account), the system provides the benefit in form of cashable credits, cashable promotional credits or non-cashable promotional credits). In certain embodiments wherein the gaming establishment account that receives the benefit in association with the financial account rewards program is a patron management system account, such as a player tracking account, the system provides the benefit in form of loyalty units, such as player tracking points or Xtra credits. For example, as also seen in FIG. 2A, the plurality of components of the system (e.g., a gaming establishment financial account rewards program system, a database which maintain the configuration of the financial account rewards program, and a patron management system) operate with one or more components external from the system (e.g., an issuer financial institution system) such that upon an occurrence of a gaming establishment account contribution event, the issuer financial institution system notifies the gaming establishment financial account rewards program system of various data associated with one or more qualifying purchases to enable the gaming establishment financial account rewards program system to determine a benefit to contribute to one or more patron management system accounts. It should be appreciated that in certain embodiments, the deposit of an amount of player tracking points to a player tracking account provides the additional benefit of potentially increasing the user's player tracking ranking or tier in the player tracking system (which aids via an increased rate of earning player tracking points for subsequent qualifying activities and/or obtaining other access benefits (e.g., invitations to exclusive events), gaming benefits (e.g., extended point or benefit expiration times), sports betting benefits (e.g., use of a dedicated window at a sports book), hotel benefits (e.g., hotel room upgrades, priority access at hotel check-in or at other amenities (e.g., pool, spa)), shopping benefits (e.g., discounts at participating retail locations), dining benefits (e.g., priority reservations), entertainment benefits (e.g., VIP line access to select nightclubs), and/or transportation benefits (e.g., complimentary valet parking).

In certain embodiments, following the contribution a benefit associated with a financial account rewards program into one or more gaming establishment accounts, the system notifies the user of the contribution of the benefit into the gaming establishment account(s) in any suitable manner, such as through telephone, e-mail, SMS or text messages, banner messages in mobile device application, social media postings, website postings or any other suitable medium. For example, a notification server of the system sends an SMS message to the user's mobile device which displays a message that they have earned a cashback award deposited into their cashless wagering account. It should be appreciated that while the notification of the benefit may be conveyed via a mobile device, in various embodiments, the notification of the benefit may be conveyed via any suitable devices, such as one or more display devices and/or one or more audio devices.

In certain embodiments, in addition to (or alternative from) notifying the user of the deposit of a benefit into one or more gaming establishment accounts, the system automatically initiates one or more activities associated with a gaming establishment using part or all of the benefit deposited into such gaming establishment accounts. In these embodiments, the system enables the user to earn one or more benefits in association with economic activity occurring independent of any gaming establishment wherein part or all of such earned benefits are then automatically redeemed in association with a gaming establishment independent of any user intervention to cause such redemption. Such a configuration enables a user to leverage economic activity occurring independent of any gaming establishment to obtain a benefit redeemable in association with the gaming establishment.

In one such embodiment, following the occurrence of the gaming establishment account contribution event and one or more benefits deposited into one or more gaming establishment accounts associated with the user, the system utilizes part or all of the benefit obtained in association with the use of the qualifying instrument associated with the financial account to purchase goods and/or services to settle part or all of an outstanding line of credit or marker associated with the user. In this embodiment, based on the user having an outstanding line of credit currently due, the system determines that the gaming establishment account contribution event qualifies as an occurrence of a line of credit repayment event and communicates one or more messages to the gaming establishment credit system to log the user into the gaming establishment credit system (if necessary). The system then attempts to pay back an amount of funds accessed from the issued line of credit of the user. Upon receiving the messages and verifying the request, the gaming establishment credit system proceeds with operating with the system to log the user into a gaming establishment account associated with the user (if necessary) and potentially transfer the amount of funds accessed from the issued line of credit of the user from the gaming establishment account associated with the user to the gaming establishment credit system to pay off part or all of the outstanding line of credit balance.

In certain embodiments, to complete a transfer of an amount of funds associated with a line of credit from the gaming establishment account that received the benefit earned in association with the financial account rewards program, the system determines whether to authorize the transfer of the determined amount of funds to pay off part or all of the issued line of credit. In these embodiments, if the system determines not to authorize the transfer of the determined amount of funds to pay off the issued line of credit (e.g., the gaming establishment account balance lacks the funds to pay off the entire amount of the issued line of credit), the system communicates a denial to the gaming establishment credit system. In certain embodiments, following the denial, one or more display devices display a denial of line of credit payoff to the user. On the other hand, if the system determines to authorize the transfer of the determined amount of funds to pay off part or all the issued line of credit (e.g., the gaming establishment account balance has adequate funds to pay off part or all of the issued line of credit), the system updates the outstanding line of credit balance (to reflect a paying off of part or all of the issued line of credit), updates the balance of the gaming establishment account (to reflect the transfer of the funds away from the gaming establishment account) and communicates an authorization of the transfer to the gaming establishment credit system. Upon receiving the authorization, the gaming establishment credit system updates the outstanding line of credit. Such a configuration offers an automatic way for a user to pay off outstanding debts associated with a gaming establishment independent of any activity associated with the gaming establishment.

In another embodiment, following one or more benefits deposited into one or more gaming establishment accounts associated with the user, the system automatically contributes part or all of the benefit determined in association with the financial account rewards program to a progressive award pool. In this embodiment, the system determines that the gaming establishment account contribution event qualifies as an occurrence of a progressive award pool contribution event and proceeds to automatically risk part or all of the amount contributed to the gaming establishment account to potentially win a progressive award.

In certain embodiments, the system maintains one or more progressive award pools that each starts or resets at a reset amount or level and increments based on contributions associated with benefits earned in association with the financial account rewards program. In certain embodiments, each of the progressive award pools associated with different rewards programs have the same progressive award pool reset value. In certain embodiments, a plurality of the progressive award pools associated with different rewards programs have different progressive award pool reset values. In these embodiments, the different progressive award pool reset values are different reward program benefits associated with a user choosing one financial account (e.g., one credit card account enrolled in one credit card rewards program) over another financial account (e.g., another credit card account enrolled in another credit card rewards program).

In one embodiment, the system maintains a single progressive award pool in association with a first set of financial accounts, such as credit card accounts. In another embodiment, the system maintains a plurality of progressive award pools in association with a first set of financial accounts, such as credit card accounts, affiliated with a single rewards program. In another embodiment, the system maintains a single progressive award pool in association with a plurality of different sets of financial accounts, such as credit card accounts, affiliated with a plurality of different rewards programs. In another embodiment, the system maintains a plurality of progressive award pools in association with a plurality of different sets of financial accounts, such as credit card accounts, affiliated with a plurality of different rewards programs.

In one embodiment, the system maintains a single progressive award pool independent of the identities of the users associated with financial accounts. For example, each user's respective player tracking status does not factor into which progressive award the benefit earned in association with the financial account rewards program is contributed into. In another embodiment, the system maintains a plurality of progressive award pools independent of the identities of the users associated with financial accounts. In another embodiment, the system maintains a plurality of progressive award pools based on the identities of the users associated with financial accounts. For example, users having a first player tracking status contribute the benefit earned in association with the financial account rewards program to a first progressive award and users having a second, different player tracking status contribute the benefit earned in association with the financial account rewards program to a second, different progressive award

In addition to maintaining a progressive award pool, following the deposit of a benefit earned in association with the financial account rewards program into the gaming establishment account, the system automatically contributes part or all of that amount to the maintained progressive award pool. In certain embodiments, the progressive award pool is funded by the deposits of the amounts contributed to the gaming establishment accounts in association with the financial account rewards program associated with that progressive award pool. In certain embodiments, the progressive award pool is additionally funded by a percentage of wagers placed at one or more gaming devices associated with the progressive award.

Following the contribution of an amount to the progressive award pool, the system determines if a progressive award triggering event occurs. In certain embodiments, a progressive award triggering event is a mystery event whereby the system does not provide any apparent reasons to the user for a progressive award triggering event to occur. In these embodiments, such determinations are not triggered by an event (beyond the contribution of an amount earned in association with the financial account rewards program) displayed to the user and the progressive award triggering event occurs without any explanation or alternatively with simple explanations.

In certain embodiments, the progressive award triggering event is based on an amount of the maintained progressive award pool. In this embodiment, the system determines if an amount of the progressive award pool reaches or exceeds a threshold amount, such as an amount randomly determined from a value range. Upon the amount of the progressive award pool reaching or exceeding the threshold amount, the system determines that the progressive award triggering event has occurred.

In another embodiment, a progressive award triggering event occurs based on time. In this embodiment, a time is set, such as via the random selection of a point in time within a designated period of time from the current point in time, for when a progressive award triggering event will occur. When that set time has elapsed, the system determines that the progressive award triggering event has occurred in association with the deposit of the benefit earned in association with the financial account rewards program. For example, the system determines that the first contribution communicated from a gaming establishment fund management system to a progressive award server, after a randomly determined point in time has been reached, is associated with the progressive award triggering event.

In another embodiment, a progressive award triggering event is based on an amount of the maintained progressive award pool reaching or exceeding a threshold amount and a set point in time having been reached. In this embodiment, upon the amount of the progressive award pool reaching or exceeding the threshold amount after a set point in time, the system determines that the progressive award triggering event has occurred. In this embodiment, upon the amount of the progressive award pool reaching or exceeding the threshold amount before a set point in time has been reached, then the system waits for that point in time such that when that set time has been reached, the system determines that the progressive award triggering event has occurred.

In another alternative embodiment, a progressive award triggering event occurs based on a predefined variable reaching a defined parameter threshold. In different embodiments, the predefined parameter thresholds include a length of time, a length of time after a certain amount has been contributed to the progressive award pool, a number of different credit cards used, a number of different participating consumers, or any other parameter that defines a suitable threshold. In another alternative embodiment, a progressive award triggering event occurs based upon defined eligibility parameters associated with one or more individual users. In another alternative embodiment, a progressive award triggering event occurs based on a determination of if any numbers allotted to transaction match a randomly selected number. In this embodiment, upon the system contributing to the progressive award based on deposit of the benefit earned in association with the financial account rewards program, the system selects a random number from a range of numbers. In this embodiment, the system also allocates the first N numbers in the range, where N is the amount of the contribution to the progressive award. The system then compares the randomly selected number with the numbers allocated to the contribution to the progressive and if a match occurs, a progressive award triggering event occurs. It should be appreciated that any suitable manner of causing a progressive award triggering event to occur may be implemented in accordance with the system and method of the present disclosure. It should be further appreciated that any of the above-described progressive award triggering events may be combined in one or more different embodiments.

If the system determines that a progressive award triggering event does not occur in association with the contribution of the benefit earned in association with the financial account rewards program to the progressive award, the system awaits for another occurrence of the progressive award pool contribution event associated with the maintained progressive award pool to again determine if a progressive award triggering event occurs. On the other hand, if the system determines that a progressive award triggering event occurred in association with the contribution of the benefit earned in association with the financial account rewards program to the progressive award, the system determines the amount of the progressive award and proceeds to reset the progressive award pool to a reset value associated with the progressive award pool. In addition to this reset, the system notifies the user that they are the winner of a progressive award (via any suitable manner, such as through telephone, e-mail, SMS or text messages, banner messages in mobile device application, social media postings, website postings or any other suitable medium) and contributes the amount of the won progressive award to the gaming establishment account associated with the winning user.

In certain embodiments wherein winning the progressive award is associated with a requirement to file a W-2G tax form with one or more taxing authorities, such as the internal revenue service, one or more components require that the user login to an applicable account and obtain or complete the W-2G tax form before a transfer of the funds of the won progressive award to an applicable account of the user. In these embodiments, the progressive award system holds the funds of the won progressive award in escrow until the user completes the required tax reporting paperwork, upon which the progressive award system completes the transfer of the funds of the won progressive award to the user's account. In certain embodiments other wherein winning the progressive award is associated with a requirement to file a W-2G tax form with one or more taxing authorities, the system transfers the funds of the won progressive award to the user's account and places a hold of the withdrawal of such funds until the user completes the required tax reporting paperwork. In these embodiments, the system places the funds of the won progressive award in a blocked state where withdraws are disabled until the user completes the process of obtaining the W-2G form for the won progressive award.

In certain embodiments, the gaming establishment financial account rewards program system causes part or all of the contribution of the benefit earned in association with the financial account rewards program to be transferred to the progressive award system, wherein the gaming establishment financial account rewards program system receives data regarding the progressive award (e.g., a current value of the progressive award, a threshold value of the progressive award) and determines whether or not the progressive award triggering event occurred. In these embodiments, following the gaming establishment financial account rewards program system determining that the progressive award triggering event occurred, the gaming establishment financial account rewards program system operates to transfer an amount of the won progressive award to a gaming establishment account maintained for the user by the gaming establishment fund management system.

In certain other embodiments, the gaming establishment financial account rewards program system causes part or all of the contribution of the benefit earned in association with the financial account rewards program to be transferred to the progressive award system, wherein following the progressive award system determining that the progressive award triggering event occurred, the progressive award system operates with the gaming establishment financial account rewards program system to transfer an amount of the won progressive award to a gaming establishment account maintained for the user by the gaming establishment fund management system. For example, as seen in FIG. 2B, in addition to a plurality of components of the system (e.g., a gaming establishment financial account rewards program system, a database which maintain the configuration of the financial account rewards program, and a gaming establishment fund management system) operating with one or more components external from the system (e.g., an issuer financial institution system) to determine a benefit to contribute to one or more gaming establishment accounts, a plurality of components of the system (e.g., the gaming establishment financial account rewards program system and a progressive award system) operate to determine whether or not the progressive award triggering event occurred and, if so, the gaming establishment financial account rewards program system causes a contribution of an amount of a progressive award to a gaming establishment account.

In certain other embodiments, the gaming establishment financial account rewards program system causes part or all of the contribution of the benefit earned in association with the financial account rewards program to be contributed to the progressive award system and following the progressive award system determining that the progressive award triggering event occurred, the progressive award system operates with the gaming establishment fund management system to transfer an amount of the won progressive award to a gaming establishment account maintained for the user by the gaming establishment fund management system. For example, as seen in FIG. 2C, in addition to a plurality of components of the system (e.g., a gaming establishment financial account rewards program system, a database which maintain the configuration of the financial account rewards program, and a gaming establishment fund management system) operating with one or more components external from the system (e.g., an issuer financial institution system) to determine a benefit to contribute to one or more gaming establishment accounts, a plurality of components of the system (e.g., the gaming establishment financial account rewards program system and a progressive award system) operate to determine whether or not the progressive award triggering event occurred and, if so, the progressive award system causes a contribution of an amount of a progressive award won to a gaming establishment account.

In certain embodiments, in addition to contributing the amount of the won progressive award to the gaming establishment account associated with the user whom won the progressive award, the system provides one or more supplemental awards, such as a percentage of the progressive award pool and/or a percentage of another award pool, to one or more other users.

In certain embodiments, as described above, upon a determination that a consumer has won a progressive award in association with a contribution of the benefit earned in association with the financial account rewards program, the system notifies the user and funds one or more gaming establishment accounts with the progressive award. In certain embodiments, the system requires the user to take one or more actions to be provided the progressive award (which the system has already determined the user has won). In certain of these embodiments, the system notifies the user that they won the progressive award via the play of one or more games. In certain embodiments, the system enables the user to play the game to determine whether or not they won the progressive award. In certain other embodiments, the system enables (or even requires) the user to make one or more inputs in association with the play of the game to determine whether or not they won the progressive award. In different embodiments, the game played to be provided the previously won progressive award is any suitable game including, but not limited to: a play of any suitable slot game; a play of any suitable wheel game; a play of any suitable card game; a play of any suitable offer and acceptance game; a play of any suitable award ladder game; a play of any suitable puzzle-type game; a play of any suitable persistence game; a play of any suitable selection game; a play of any suitable cascading symbols game; a play of any suitable ways to win game; a play of any suitable scatter pay game; a play of any suitable coin-pusher game; a play of any suitable elimination game; a play of any suitable stacked wilds game; a play of any suitable trail game; a play of any suitable bingo game; a play of any suitable video scratch-off game; a play of any suitable pick-until-complete game; a play of any suitable shooting simulation game; a play of any suitable racing game; a play of any suitable promotional game; a play of any suitable high-low game; a play of any suitable lottery game; a play of any suitable number selection game; a play of any suitable dice game; a play of any suitable skill game; a play of any suitable auction game; a play of any suitable reverse-auction game; and/or a play of any suitable group game.

In another embodiment, following one or more benefits deposited into one or more gaming establishment accounts associated with the user, the system automatically contributes part or all of the benefit determined in association with the financial account rewards program to purchase a quantity of entries into a drawing. In this embodiment, the system determines that the gaming establishment account contribution event qualifies as an occurrence of a drawing entry purchase event and proceeds to automatically risk part or all of the amount contributed to the gaming establishment account to potentially win the award associated with the drawing.

In one embodiment, the system runs a single drawing in association with a first set of financial accounts, such as credit card accounts. In another embodiment, the system runs a plurality of drawings in association with a first set of financial accounts, such as credit card accounts, affiliated with a single rewards program. In another embodiment, the system runs a single drawing in association with a plurality of different sets of financial accounts, such as credit card accounts, affiliated with a plurality of different rewards programs. In another embodiment, the system runs a plurality of drawings in association with a plurality of different sets of financial accounts, such as credit card accounts, affiliated with a plurality of different rewards programs.

In one embodiment, the system runs a single drawing independent of the identities of the users associated with financial accounts. In another embodiment, the system runs a plurality of drawings independent of the identities of the users associated with financial accounts. In another embodiment, the system runs a plurality of drawings based on the identities of the users associated with financial accounts.

In these embodiments, following the deposit of a benefit earned in association with the financial account rewards program into the gaming establishment account, the system automatically purchases a quantity of entries into the run drawing using part or all of the deposited amount. Such purchases fund a pool used to determine an award for winning the drawing.

Following the purchase of the quantity of entries, the system awaits for the drawing to occur. Upon the occurrence of the drawing, the system determines if any of the user's purchased entries qualify as a winning entry, such as if the purchased drawing is a randomly selected drawing. Upon at least one of the user's purchased entries qualifying as a winning entry, the system determines the amount of the award for winning the drawing and contributes the determined amount to the gaming establishment account associated with the user. In addition to this contribution for winning the drawing, the system notifies the user that they are the winner of the drawing (via any suitable manner, such as through telephone, e-mail, SMS or text messages, banner messages in mobile device application, social media postings, website postings or any other suitable medium).

In certain embodiments, the gaming establishment financial account rewards program system causes part or all of the contribution of the benefit earned in association with the financial account rewards program to be transferred to a drawing manager which, upon the occurrence of the drawing, determines whether or not a purchased entry is a winning entry in the drawing. For example, as seen in FIG. 2D, in addition to a plurality of components of the system (e.g., a gaming establishment financial account rewards program system, a database which maintain the configuration of the financial account rewards program, and a gaming establishment fund management system) operating with one or more components external from the system (e.g., an issuer financial institution system) to determine a benefit to contribute to one or more gaming establishment accounts, a plurality of components of the system (e.g., the gaming establishment financial account rewards program system, the gaming establishment fund management system and a drawing manager) operate to purchase one or more entries into a drawing (with part or all of the funds obtained from the rewards program), run the drawing, determine whether a purchased entry is a winning entry and, if so, cause a contribution of an amount of an award for winning the drawing to a gaming establishment account.

It should be appreciated that any functionality or process of the present disclosure may be implemented via one or more gaming establishment servers (associated with or independent of any component of any system of the present disclosure), one or more non-gaming establishment servers (associated with or independent of any component of any system of the present disclosure), one or more gaming establishment devices (e.g., a gaming device such as an EGM), one or more components of a gaming establishment device (such as a component of a gaming establishment management system supported by or otherwise located inside the gaming establishment device), one or more non-gaming devices (e.g., a point-of-sale terminal) or a mobile device application. For example, while certain data or information of the present disclosure is explained as being communicated from a component of a gaming establishment financial account rewards program system to a component of the gaming establishment fund management system, such data or information may additionally or alternatively be communicated from one or more servers to component of a patron management system.

In various embodiments, one or more of the above-described components of (or otherwise associated with) the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager each includes at least one processor. The at least one processor of these devices is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source via a communication interface; (2) converting signals read by an interface to a format corresponding to that used by software or memory of that device; (3) accessing memory to configure or reconfigure parameters in the memory according to received data; (4) communicating with interfaces and zero, one or more peripheral devices (such as input/output devices); and/or (5) controlling zero, one or more peripheral devices.

In various embodiment, one or more of the above-described components of (or otherwise associated with) the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager each also includes at least one memory device, which includes: (1) volatile memory (e.g., RAM, which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information. Any other suitable magnetic, optical, and/or semiconductor memory may operate in conjunction with these devices. In certain embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The at least one memory device is configured to store, for example: (1) configuration software, such as all the parameters and settings for that device; (2) associations between configuration indicia received and one or more parameters and settings; (3) communication protocols configured to enable the at least one processor to communicate with zero, one or more peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the device to communicate with local and non-local devices using such protocols. In one implementation, one or more of such devices communicate with other devices using a serial communication protocol.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of one or more above-described components of the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager to control that device. The at least one memory device also stores other operating data, such as image data, event data, input data, random number generators or pseudo-random number generators, and/or applicable rules that relate to the operation of such devices. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator uses such a removable memory device to implement at least part of the present disclosure. In other embodiments, part or all of the program code and/or the operating data is downloaded to the at least one memory device through any suitable data network described above (such as an Internet or intranet).

The at least one memory device also stores a plurality of device drivers. Examples of different types of device drivers include device drivers for components of one or more of the point-of-sale terminal, banking network server, issuer financial institution server, progressive award server, notification server, online game engine, game entry engine, and device drivers for the peripheral components. Typically, the device drivers utilize various communication protocols that enable communication with a particular physical device. The device driver abstracts the hardware implementation of that device. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the one or more above-described components of the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager loads the new device driver from the at least one memory device to enable communication with the new device.

In certain embodiments, the software units stored in the at least one memory device can be upgraded as needed. For instance, when the at least one memory device is a hard drive, new options, new parameters, new settings for existing parameters, new settings for new parameters, new device drivers, and new communication protocols can be uploaded to the at least one memory device from one or more above-described components of the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components and/or information, such as hardware components, software components, firmware components, peripheral device components, user input device components, information received from one or more user input devices, information stored in the at least one memory device, etc.

In certain embodiments, the peripheral devices include several device interfaces, such as: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; and (13) at least one information filtering module.

The at least one output device includes at least one display device configured to display any suitable information associated with the rewards program of the present disclosure. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, the display device includes a touch-screen with an associated touch-screen controller. The display devices may be of any suitable sizes, shapes, and configurations.

In certain embodiments, the at least one output device is a sound generating device controlled by one or more sound cards. In one such embodiment, the sound generating device includes one or more speakers or other sound generating hardware and/or software configured to generate sounds.

The at least one input device may include any suitable device that enables an input signal to be produced and received by the at least one processor.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices. In one embodiment, a user input device docking region is provided, and includes a power distribution component that is configured to recharge a user input device without requiring metal-to-metal contact. In one embodiment, the at least one power distribution component is configured to distribute power to one or more internal components, such as one or more rechargeable power sources (e.g., rechargeable batteries).

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity; detecting the presence and/or identity of various persons (e.g., customers, retail establishment employees, etc.), devices (e.g., user input devices), and/or systems within a predetermined proximity.

The at least one data preservation component is configured to detect or sense one or more events and/or conditions that, for example, may result in damage to the one or more above-described components of the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager and/or that may result in loss of information. Additionally, the data preservation system may be operable to initiate one or more appropriate action(s) in response to the detection of such events/conditions.

The at least one motion/gesture analysis and interpretation component is configured to analyze and/or interpret information relating to detected movements and/or gestures to determine appropriate input information relating to the detected movements and/or gestures. For example, in one embodiment, the at least one motion/gesture analysis and interpretation component is configured to perform one or more of the following functions: analyze the detected gross motion or gestures of a customer; interpret the customer's motion or gestures to identify instructions or input from the customer. In other embodiments, at least a portion of these additional functions may be implemented at a remote system or device.

The at least one portable power source enables the one or more above-described components of the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager to operate in a mobile environment. For example, in one embodiment, the point-of-sale terminal includes one or more rechargeable batteries.

The at least one geolocation module is configured to acquire geolocation information from one or more remote sources and use the acquired geolocation information to determine information relating to a relative and/or absolute position of the one or more above-described components of (or otherwise associated with) the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager. For example, in one implementation, the at least one geolocation module is configured to receive GPS signal information for use in determining the position or location of a point-of-sale terminal. In another example, the at least one geolocation module is configured to receive multiple wireless signals from multiple remote devices and use the signal information to compute position/location information relating to the position or location of the point-of-sale terminal.

The at least one information filtering module is configured to perform filtering (e.g., based on specified criteria) of selected information to be displayed at one or more displays.

In various embodiments, one or more of the above-described components of (or otherwise associated with) the system, such as one or more of the point-of-sale terminal, a component of the issuer financial institution system, a component of the gaming establishment financial account rewards program system, a component of the gaming establishment fund management system, a component of the patron management system, the progressive award server, the notification server, and/or the drawing manager includes a plurality of communication ports configured to enable the at least one processor to communicate with and to operate with external peripherals, such as: accelerometers, arcade sticks, bar code readers, bill validators, biometric input devices, button panels, card readers, display screens or other displays or video sources, expansion buses, information panels, keypads, lights, mass storage devices, microphones, motion sensors, motors, printers, SCSI ports, solenoids, speakers, thumbsticks, ticket readers, touch screens, trackballs, touchpads, wheels, and wireless communication devices.

In different embodiments, the various components of (or otherwise associated with) the system, such as the point-of-sale terminal, a component of the issuer financial institution system, a component of the gaming establishment financial account rewards program system, a component of the gaming establishment fund management system, a component of the patron management system, the progressive award server, the notification server, and/or the drawing manager, each includes one or more interfaces for communicating with each other utilizing one or more wired connections (such as, but not limited to: a conventional phone line or other data transmission line, a digital subscriber line (DSL), a T-1 line, a coaxial cable, a fiber optic cable) and/or one or more wireless communication protocols (such as, but not limited to: Bluetooth™ Bluetooth™ Low Energy (“BLE”), one or more cellular communication standards (e.g., 3G, 4G, LTE), one or more Wi-Fi compatible standards, and one or more short range communication protocols (e.g., a near field communication (“NFC”) protocol)).

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
following an approved purchase made in association with a financial account maintained for a user by a financial institution and responsive to a gaming establishment account contribution event:
cause an amount to be contributed to a gaming establishment account associated with the user, wherein the amount contributed to the gaming establishment account is based on a purchase contribution rate and an amount of the approved purchase, and
responsive to the amount contributed to the gaming establishment account associated with the user:
communicate data that results in a display, by a display device, of the amount contributed to the gaming establishment account, and
automatically initiate an activity associated with a gaming establishment, wherein the activity is at least partially funded by at least part of the amount contributed to the gaming establishment account.

2. The system of claim 1, wherein the gaming establishment account comprises a cashless wagering account and the contributed amount comprises an amount of cashable funds.

3. The system of claim 1, wherein the gaming establishment account comprises a player tracking account and the contributed amount comprises an amount of player tracking points.

4. The system of claim 1, wherein a first approved purchase is associated with a first purchase contribution rate and a second, different approved purchase is associated with a second, different purchase contribution rate.

5. The system of claim 1, wherein a first approved purchase associated with a first amount of funds is associated with a first contribution to the gaming establishment account and a second, different approved purchase associated with the first amount of funds is associated with a second, different contribution to the gaming establishment account.

6. The system of claim 5, wherein the first contribution to the gaming establishment account comprises a first type of credit and the second, different contribution to the gaming establishment account comprises a second, different type of credit.

7. The system of claim 1, wherein the activity associated with the gaming establishment comprises an automatic initiation of a settlement of an outstanding marker liability associated with the user.

8. The system of claim 1, wherein the activity associated with the gaming establishment comprises an automatic contribution to a progressive award, and when executed by the processor responsive to an occurrence of a randomly determined triggering event, the instructions cause the processor to cause a modification of the gaming establishment account associated with the user based on the progressive award.

9. The system of claim 1, wherein the activity associated with a gaming establishment comprises an automatic purchase of a quantity of entries in a drawing, and when executed by the processor responsive to one of the purchased quantity of entries in the drawing being a winning entry, the instructions cause the processor to cause a modification of the gaming establishment account associated with the user based on an award associated with the drawing.

10. A system comprising:
a processor; and
a memory device that stores a plurality of instructions that, when executed by the processor, cause the processor to:
responsive to an approved purchase made in association with a financial account maintained for a user by a financial institution and responsive to a gaming establishment account contribution event:
determine a benefit, wherein the benefit is determined independent of any wagering activity occurring in association with any gaming establishment and an amount of the benefit is based on a purchase contribution rate and an amount of the approved purchase,
cause the determined benefit to be contributed to a gaming establishment account associated with the user, and
cause the determined benefit to be automatically applied toward a wagering activity occurring in association with a gaming establishment.

11. The system of claim 10, wherein when executed by the processor, the instructions cause the processor to cause the determined benefit to be automatically applied toward the wagering activity independent of any inputs received by the user.

12. A method of operating a system, the method comprising:
following an approved purchase made in association with a financial account maintained for a user by a financial institution and responsive to a gaming establishment account contribution event:
causing, by a processor, an amount to be contributed to a gaming establishment account associated with the user, wherein the amount contributed to the gaming establishment account is based on a purchase contribution rate and an amount of the approved purchase, and
responsive to the amount contributed to the gaming establishment account associated with the user:
displaying, by a display device, the amount contributed to the gaming establishment account, and
automatically initiating, by the processor, an activity associated with a gaming establishment, wherein the activity is at least partially funded by at least part of the amount contributed to the gaming establishment account.

13. The method of claim 12, wherein the gaming establishment account comprises a cashless wagering account and the contributed amount comprises an amount of cashable funds.

14. The method of claim 12, wherein the gaming establishment account comprises a player tracking account and the contributed amount comprises an amount of player tracking points.

15. The method of claim 12, wherein a first approved purchase is associated with a first purchase contribution rate and a second, different approved purchase is associated with a second, different purchase contribution rate.

16. The method of claim 12, wherein a first approved purchase associated with a first amount of funds is associated with a first contribution to the gaming establishment account and a second, different approved purchase associated with the first amount of funds is associated with a second, different contribution to the gaming establishment account.

17. The method of claim 16, wherein the first contribution to the gaming establishment account comprises a first type of credit and the second, different contribution to the gaming establishment account comprises a second, different type of credit.

18. The method of claim 12, wherein the activity associated with the gaming establishment comprises an automatic initiation of a settlement of an outstanding marker liability associated with the user.

19. The method of claim 12, wherein the activity associated with the gaming establishment comprises an automatic contribution to a progressive award, and further comprising, responsive to an occurrence of a randomly determined triggering event, causing, by the processor, a modification of the gaming establishment account associated with the user based on the progressive award.

20. The method of claim 12, wherein the activity associated with a gaming establishment comprises an automatic purchase of a quantity of entries in a drawing, and further comprising, responsive to one of the purchased quantity of entries in the drawing being a winning entry, causing, by the processor, a modification of the gaming establishment account associated with the user based on an award associated with the drawing.
